(19) United States
(12) Patent Application Publication
(10) Pub. No.: US 2010/0198676 A1
(43) Pub. Date: Aug. 5, 2010

(54) METHOD AND SYSTEM FOR REWARD AUDITING

(75) Inventors: Daniel A. Sperau, Baltimore, MD (US); Melissa Sperau, Baltimore, MD (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: DS & ASSOCIATES LLC, Baltimore, MD (US)

(21) Appl. No.: 12/524,704

(22) PCT Filed: Jan. 28, 2008
(86) PCT No.: PCT/US08/01186

§ 371 Date: Apr. 12, 2010

Related U.S. Application Data
(60) Provisional application No. 60/897,514, filed on Jan. 26, 2007.

(51) Int. Cl. G06Q 30/00; G06Q 10/00; G06Q 50/00

(52) U.S. Cl. 705/14.26; 705/14.1; 705/14.34

(57) ABSTRACT

A computer system and method for managing customer rewards, such as automobile rebates, incentives, money back, and percentage rates. The system accesses a manufacturer data processing system that includes a reward information associated with a product, determines whether a reward is available for a product from the reward information, and notifying a customer when the reward is available. The system may also claim the reward.

### RELATED APPLICATION DATA

This application claims the benefit of the filing date and priority to the following patent application, which is incorporated herein by reference to the extent permitted by law:

U.S. Provisional Patent Application No. 60/897,514, entitled “Method and System for Reward Auditing,” filed Jan. 26, 2007.

### FIELD OF INVENTION

The present invention generally relates to data processing systems; and more particularly to computer-implemented methods and systems for automatically auditing manufacturer rewards, such as rebates, incentive, and money back.

### BACKGROUND OF THE INVENTION

The automobile sales business has become ever more complex with the introduction of rebates, incentives, and money to dealers or consumers. Rebates, incentives, money to dealers, percentage rates, and the like are referred to herein as “rewards” or “rebates.” Although manufacturers offer rewards to both dealerships and consumers, the programs for claiming these rewards are typically lengthy, detailed, and confusing. Also, problems arise within individual dealerships with the handling and claiming of the rewards from the manufacturers. For example, some of the problems encountered by the dealerships include:
manufacturers may change the programs with little or no notice;
dealerships must meet eligibility and compatibility requirements and restrictions;
training dealership personnel to use the programs is complicated by rapid turnover and the lack of being informed of the current and new programs;
due to variability among trainers and large numbers of personnel, it is difficult to assure uniformity in use of the programs;
the tremendous volume of vehicles sold and the number of reward programs involved with each vehicle maximize errors; and
the programs are extremely confusing due to small details that are easy to overlook.

Given these and other problems, already complicated reward programs developed by manufacturers are further complicated by manual and human error. Many dealerships have hired individuals to perform expensive yearly audits of sales, identify errors, and submit claims to the manufacturer in order to recoup some of the money owed them. As a result, many rewards are not claimed by the dealership or the customer.

### SUMMARY OF THE INVENTION

Methods, systems, and articles of manufacture consistent with the present invention reduce the problems faced by dealerships and customers from recovering rewards from manufacturers. The system can automatically, or a user can manually, audit automobile sales pertaining to rewards passed from the manufacturer to the individual dealership or customer. The system determines unclaimed rewards so that a dealership, for example, may claim them on behalf of the dealership or customer. Following the eligibility and compatibility requirements and restrictions of the manufacturer, the system collects sales information from the dealership, analyzes it, automatically determines appropriate available unclaimed rewards and notifies the user of the rewards and may automatically claim the rewards.

In accordance with methods consistent with the present invention, a method in a data processing system having a reward auditing program for managing customer rewards is provided. The method performed by the reward auditing program comprises the steps of: accessing a manufacturer data processing system that includes a reward information associated with a product; determining whether a reward is available for a product from the reward information; and notifying a customer when the reward is available.

In accordance with computer-readable mediums consistent with the present invention, a computer-readable medium containing instructions that cause a data processing system to perform a method for managing customer rewards is provided. The method comprises the steps of: accessing a manufacturer data processing system that includes a reward information associated with a product; determining whether a reward is available for a product from the reward information; and notifying a customer when the reward is available.

In accordance with systems consistent with the present invention, a data processing system is provided that comprises a memory having a reward auditing program for managing customer rewards that accesses a manufacturer data processing system that includes a reward information associated with a product, determines whether a reward is available for a product from the reward information, and notifies a customer when the reward is available. A processing unit runs the program.

The above-mentioned and other features, utilities, and advantages of the invention will become apparent from the following detailed description of the preferred embodiments of the invention together with the accompanying drawings.

Other systems, methods, features, and advantages of the invention will become apparent to one having skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention.

FIG. 1 is a block diagram of an illustrative data processing system consistent with the present invention.

FIG. 2 is a block diagram of a user system consistent with the present invention.

FIG. 3 is a block diagram of a reward auditing system consistent with the present invention.

FIG. 4 is a block diagram of a manufacturer system consistent with the present invention.

FIG. 5 is a flow diagram depicting illustrative steps performed by the reward auditing program for auditing rewards.

FIG. 6 is a flow diagram depicting illustrative steps performed by the reward auditing program for determining eligibility and compatibility of a reward program.

FIG. 7 is a screen shot of an introductory menu screen.

FIG. 8 is a screen shot of a claim history menu screen.

FIG. 9 is a screen shot of a vehicle claim history screen.

FIG. 10 is a screen shot of a vehicle specific eligibility screen.

FIG. 11 is a screen shot of another vehicle specific eligibility screen.

FIG. 12 is a screen shot of another vehicle specific eligibility screen.

FIG. 13 is a screen shot of another vehicle specific eligibility screen.

FIG. 14 is a screen shot of a program profile screen.

FIG. 15 is a screen shot of another program profile screen.

FIG. 16 is a screen shot of another program profile screen.

FIG. 17 is a screen shot of another program profile screen.

FIG. 18 is a screen shot of a claim entry screen.

FIG. 19 is a screen shot of a payment summary screen.

### DETAILED DESCRIPTION OF THE PRESENTLY PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention reduce the problems faced by retailers, such as dealerships, and customers from recovering rewards from manufacturers. Although methods, systems, and articles of manufacture described herein are described with respect to automobiles, they may be utilized with respect of other types of products, businesses, items, rewards, or financial programs. The system automatically, or a user can manually, audit automobile sales pertaining to rewards passed from the manufacturer to the individual dealership or customer. The system determines unclaimed rewards so that a dealership, for example, may claim them on behalf of the dealership or customer. Following the eligibility and compatibility requirements and restrictions of the manufacturer, the system collects sales information from the dealership, analyzes it, automatically determines appropriate available unclaimed rewards and notifies the user of the rewards and may automatically claim the rewards.

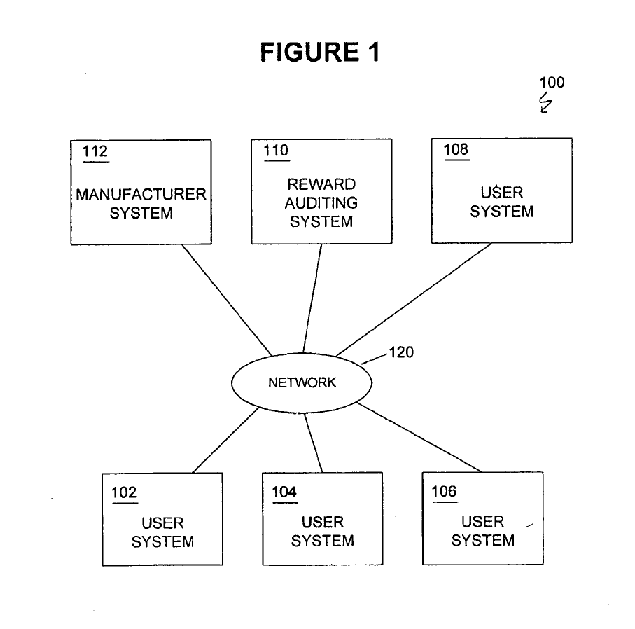

FIG. 1 shows an illustrative data processing system 100 consistent with the present invention. In the illustrative example, several user computers 102, 104, 106, and 108 communicate with a reward auditing system 110 and a manufacturer system 112 via a network 120. The user systems may be, for example, computers located at one or more automobile dealer, and the like. There may be any number of user, reward auditing and manufacturer systems. Their interaction is described in detail below.

In the illustrative example, the various components communicate via the Internet using cable modems, dial-up modems, and the like. Users access the data processing system through a web browser interface. The reward auditing system includes a web server and the user systems include a web browser. The information displayed in the web browser is transmitted from the reward auditing system, which is a server, using TCP/IP and other protocols. The various programs and modules may be implemented in hypertext markup language and other languages supported by the web browser.

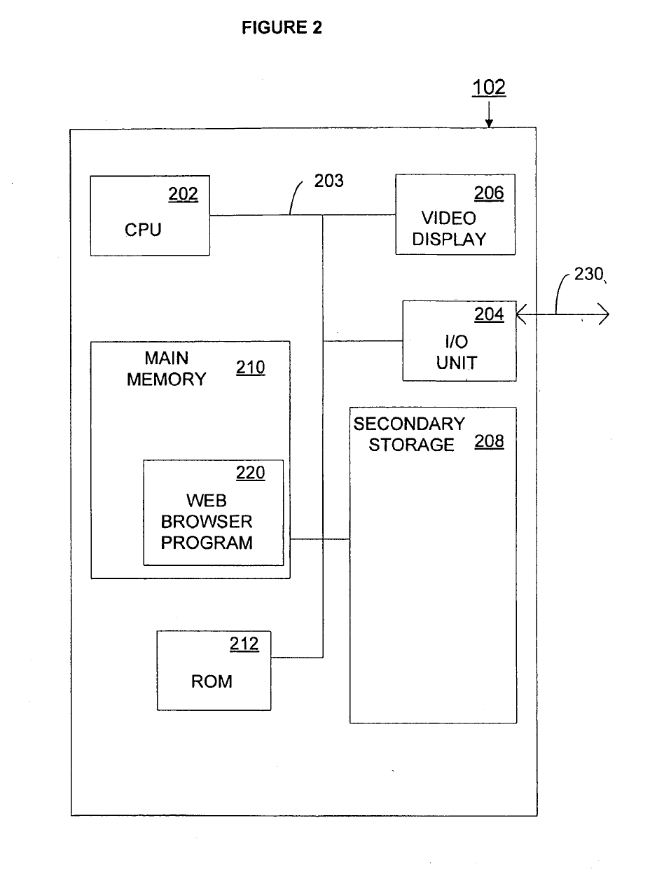

FIGS. 2, 3, and 4 depict more detailed views of an illustrative user system 102, an illustrative reward auditing system 110, and an illustrative manufacturer system 112, respectively. FIG. 2 depicts a more detailed view of a user system, such as user system 102. The user system comprises a central processing unit (CPU) 202, a display device 206, and a main memory 210 that communicate over a bus 203 or other communication mechanism. The main memory may be, for example, random access memory (RAM) or other dynamic storage memory. The user system may further comprise standard input devices such as a keyboard, a mouse or a speech processing means (each not illustrated). Main memory 210 includes a web browser program 220, such as Microsoft Internet Explorer and the like, that allows a user to access the reward auditing system and manufacturer system. In addition, main memory 210 may be used to store temporary variables or other intermediate information during execution of instructions to be executed by central processing unit 202. The user system also includes a read only memory (ROM) 212 or other static storage device coupled to bus 203 for storing static information and instructions for central processing unit 202. A secondary storage 208, such as a magnetic disk or optical disk, is provided and coupled to bus 203 for storing information and instructions. As noted above, the user system may be located at an automobile dealership, or may be located at a different location.

According to one embodiment, central processing unit 202 executes one or more sequences of one or more instructions contained in main memory 210. Such instructions may be read into main memory 210 from another computer-readable medium, such as secondary storage 208. Execution of the sequences of instructions in main memory 210 causes processor 202 to perform the process steps described herein. One or more processors in a multi-processing arrangement may also be employed to execute the sequences of instructions contained in main memory 210.

User system 102 also includes a communication interface 204 coupled to bus 203. Communication interface 204 provides a two-way data communication coupling to a network link 230 that is connected to the network. For example, communication interface 204 may be a network interface card. As another example, communication interface 204 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 204 sends and receives signals that carry digital data streams representing various types of information.

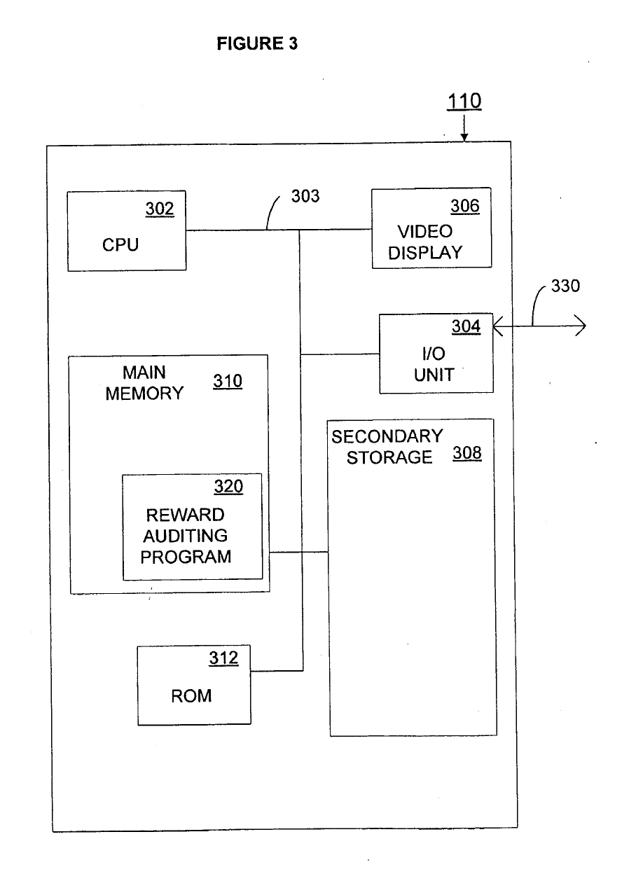

FIG. 3 depicts a more detailed view of the reward auditing system 110. The reward auditing system comprises a central processing unit (CPU) 302, a communication interface 304, a display device 306, a secondary storage 308, a main memory 310, and a read only memory 312 that communicate over a bus 303. Communication interface 304 provides a two-way data communication coupling to a network link 330 that is connected to the network. Each of these components is similar to those described above with reference to the user system. The reward auditing system may further comprise standard input devices such as a keyboard, a mouse or a speech processing means (each not illustrated). Memory 310 includes a reward auditing program 320, which is described in more detail below.

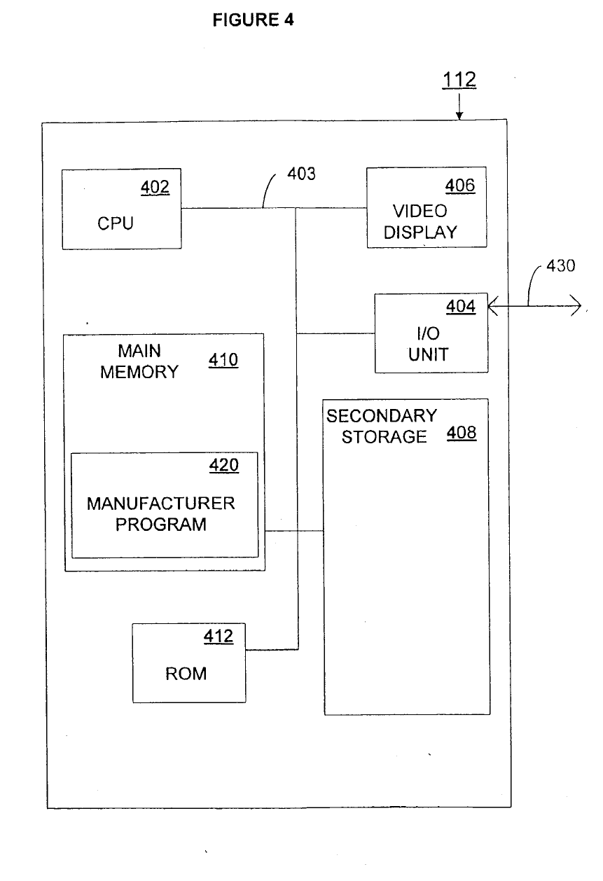

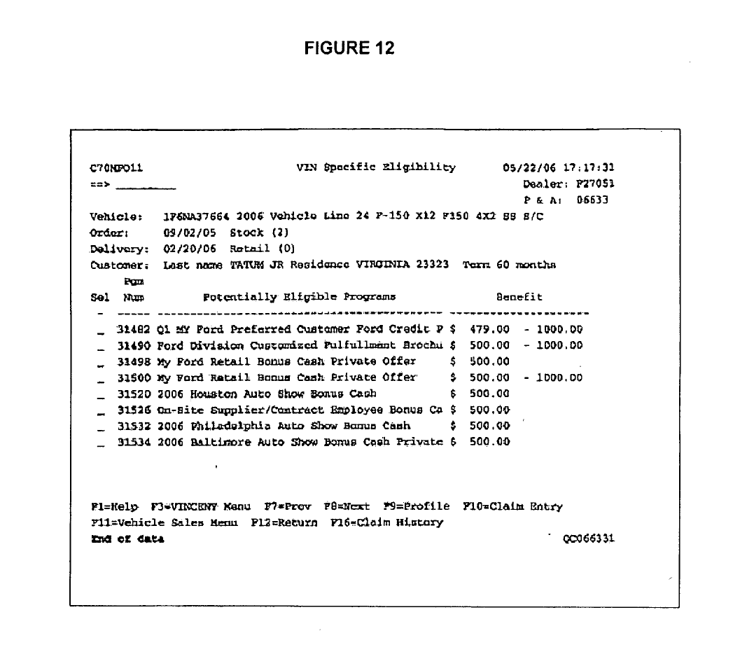

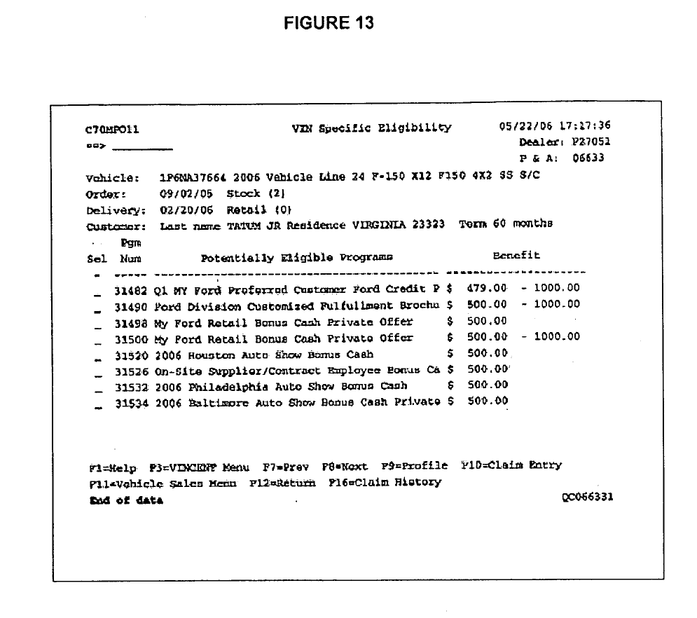

FIG. 4 depicts a more detailed view of the manufacturer system 112. The manufacturer system comprises a central processing unit (CPU) 402, a communication interface 404, a display device 406, a secondary storage 408, a memory 410, and a read only memory 412 that communicate over a bus 403. Communication interface 404 provides a two-way data communication coupling to a network link 430 that is connected to the network. Each of these components is similar to those described above with reference to the user system. The manufacturer system may further comprise standard input devices such as a keyboard, a mouse or a speech processing means (each not illustrated). Memory 410 includes a manufacturer program 420, which provides reward information to the reward auditing program. In the illustrative example, the manufacturer program is the Vincent program used for Ford Motor Company vehicle rewards, which presents the website screens shown in FIGS. 1-19. One having skill in the art will appreciate that the manufacturer program will vary from manufacturer to manufacturer and may be administered by a party other than the manufacturer. For example, the manufacturer program may alternatively be the General Motors Dealer World program, the Chrysler Dealer Connect program, and the like. The Vincent program and other manufacturer reward information programs and web sites are known in the art and will not be described in more detail herein. Vincent, Ford, Ford Motor Company, General Motors, Dealer World, Chrysler, Dealer Connect, and other names used herein may be trademarks or registered trademarks of their respective owners.

One having skill in the art will appreciate that each program and module described herein can be a stand-alone program and can reside in memory on a data processing other than the described systems. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with the described system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; or other forms of ROM or RAM either currently known or later developed. Further, although specific components of data processing system 100 have been described, one skilled in the art will appreciate that a data processing system suitable for use with methods, systems, and articles of manufacture consistent with the present invention may contain additional or different components.

One having skill in the art will appreciate that the user, reward auditing, and manufacturer systems can themselves also be implemented as client-server data processing systems. In that case, a program or module can be stored on, for example, the reward auditing system as a client, while some or all of the steps of the processing of the program or module described below can be carried out on a remote server, which is accessed by the server over the network. The remote server can comprise components similar to those described above with respect to the reward auditing system, such as a CPU, an I/O, a memory, a secondary storage, and a display device.

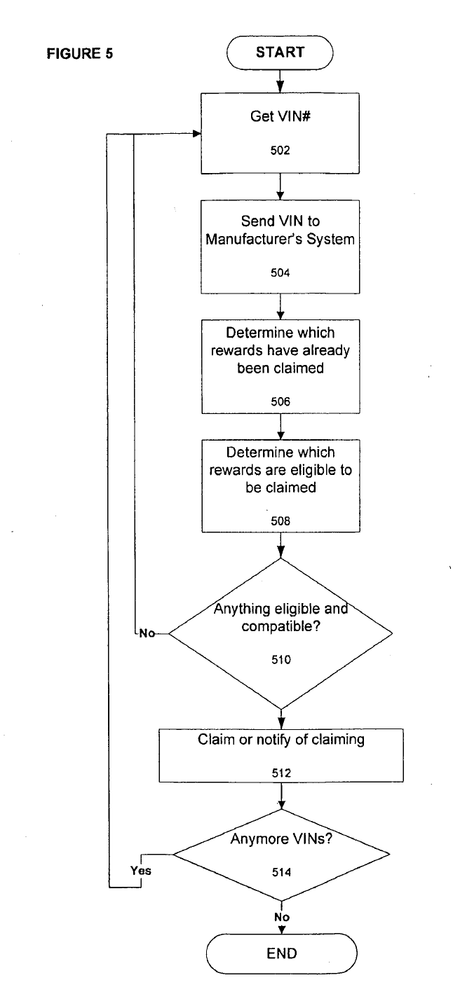

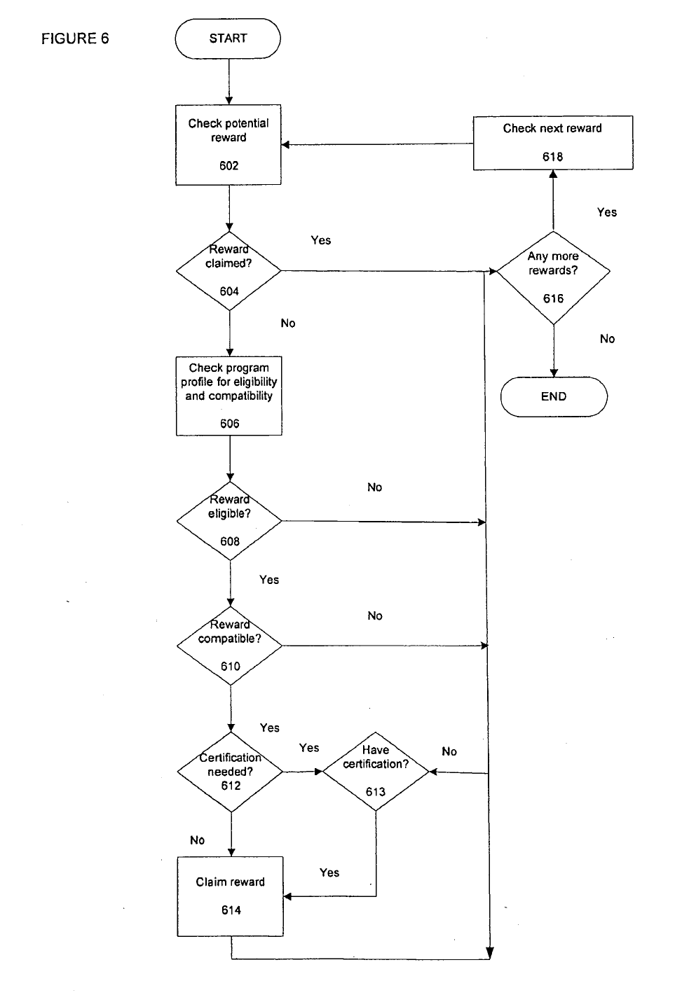

FIG. 5 depicts a flowchart that shows illustrative steps performed by the reward auditing program for auditing rewards. In the illustrative example, each of the steps described below with reference to FIGS. 5 and 6 are performed automatically by the reward auditing program. In other embodiments, one or more of the illustrative steps may be performed manually by a user or in combination with automatically by the reward auditing program. First, the reward auditing program receives one or more vehicle identification numbers (VIN) from a user (step 502). This is performed for example, by the user entering the VIN numbers into the web browser interface on the user system and these VIN numbers being received via the Internet at the reward auditing program on the reward auditing system. In another example, the VIN numbers may be sent to a person at the reward auditing system who receives the VIN numbers, for example, via e-mail, fax, or mail, and inputs the VIN numbers into the reward auditing system. If a user submits the VIN numbers via the reward auditing system website, the VIN number may be entered manually on the website, received by e-mail, uploaded in a Word or Excel document, or any other suitable method. In yet another example, if VIN numbers are sent directly to the company operating the reward auditing system, then they may be in the above formats, faxed, mailed, e-mailed or any other suitable method.

Then, the reward auditing program sends the received VIN numbers to the manufacturer system (step 504). In the illustrative example, the reward auditing program automatically logs onto the manufacturer system website via the user system or via the reward auditing system using the dealer's login information. In one implementation, the reward auditing program goes to the manufacturer system website, which is determined by the dealership being audited. For example, if the dealer is a Ford dealer, the reward auditing program accesses Ford's manufacturer website. Once there, the reward auditing program inputs the dealer's login information, which has been provided by the auditing dealership to the auditing company operating the reward auditing system. The login process may be different for each manufacturer.

Once logged onto the manufacturer system, the reward auditing program provides the manufacturer system with the received VIN numbers using a suitable method (e.g., spreadsheet, individual entries, and the like.) The reward auditing program then navigates to the manufacturer website reward screens. One having skill in the art will appreciate that although portions of the description herein describe examining information on various website screens of the manufacturer system, the reward auditing program may receive, interact with and manipulate the respective information without the appearance or examination of visual screens.

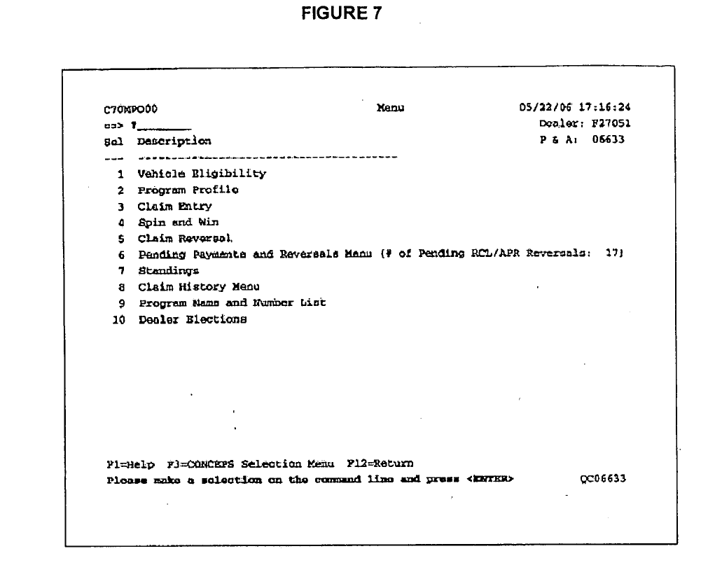

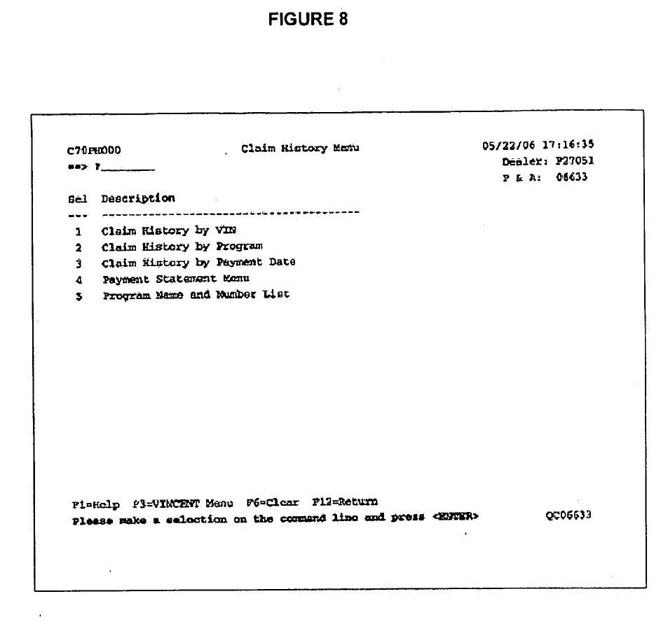

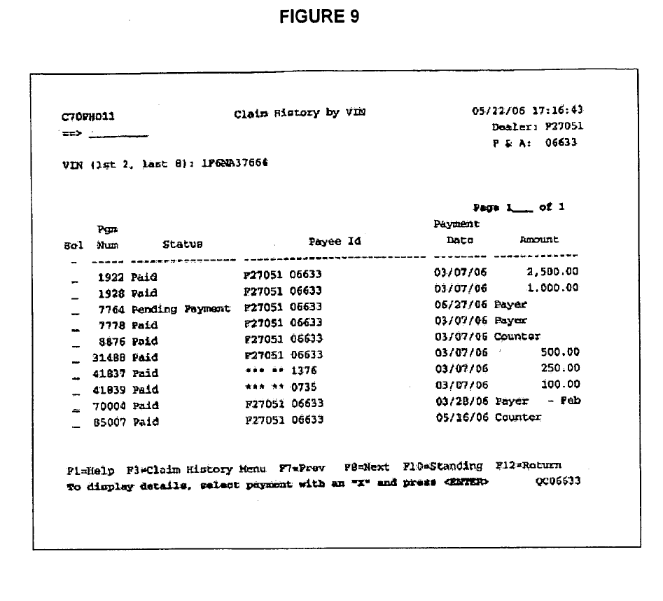

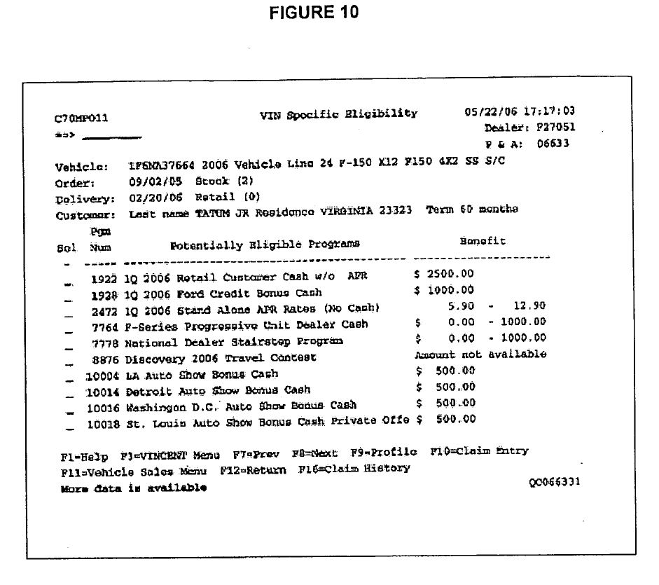

For example, FIG. 7 shows an exemplary screen shot of the menu page of an illustrative Vincent website for Ford Motor Company rewards. Here, the reward auditing program may choose, for example, two of the ten illustrative options listed to determine what rewards are eligible and which rewards have been claimed. In the illustrative example, the reward auditing program selects option 1—Vehicle Eligibility to identify eligible rewards and option 8—Claim History Menu to identify which rewards have been claimed. As will be described in more detail below, after selecting option 1, the reward auditing program may proceed to the screens shown in FIGS. 10-13 to identify eligible programs. Upon selection of option 8, the reward auditing program proceeds to the screen shown in FIG. 8 to identify what has been claimed. From the screen shown in FIG. 8, the reward auditing program may select option 1—Claim History by VIN. After this selection of option 1 on the screen shown in FIG. 8, the reward auditing program proceeds to the claim history screen shown in FIG. 9, which identifies what has already been claimed.

The reward auditing program then determines which rewards have already been claimed (step 506) and which rewards are eligible to be claimed (step 508). After a VIN number is entered, the reward auditing program identifies which rewards have been claimed via the screen in FIG. 9 and which rewards are eligible via the screens in FIGS. 10-13. FIGS. 10-13 show all eligible rewards to be claimed and includes the rewards from FIG. 9. In the illustrative example, FIGS. 10-13 show all rewards, and when rewards are claimed they appear on the screen in FIG. 9.

The screen shown in FIG. 9 depicts the rewards already claimed for this VIN number. In FIG. 9, the program number (shown as “pgm num’), the status (paid, reversed or pending payment), the payee identification (representing who was paid shown as the dealer code, sales staff or the customer; in this example the numbers in the payee ID represent the Ford ID number and parts code used by Ford to pay the dealerships), the payment date, and the amount (shown as the dollar value, number of payers, or other counter numbers to count to a set goal for tracking various program targets). In the illustrative example shown, for program number 1922, the status is “paid”, the payee id is “F27051 06633”, the payment date is Mar. 7, 2006, and the amount is $2500.

The screens depicted in FIGS. 10-13 show, for example, eligible rewards for the same VIN number for the sold date. The information represented in FIGS. 10-13 includes, but is not limited to: the program numbers (shown as “pgm num”), the potentially eligible program (shown as the individual program names), and the benefit (shown as dollar value or amount not available). The system determines what rewards are available to be claimed from the screens in FIGS. 10-13 by comparing them to rewards that have already been claimed as shown in FIG. 9 (step 506). This is performed for example, by parsing the screen information data (e.g., by screen scraping) to identify the rewards and then comparing the values of the identified rewards. In one implementation, if a reward has already been claimed, it is no longer eligible to be claimed again. In another example, the reward auditing program can parse the web page HTML data.

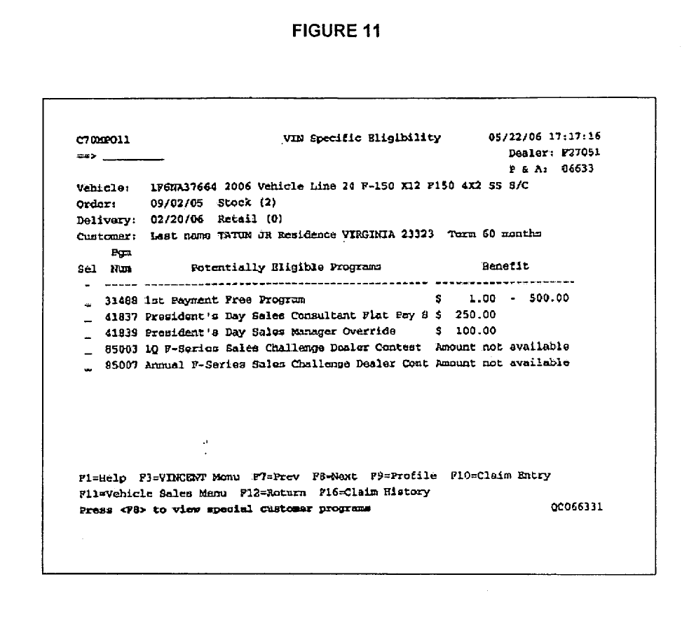

In the illustrative example of FIG. 10, for VIN 1F6NA37664, which is a F-150, potentially eligible programs include program number 1922, which is identified as “1Q 2006 Retail Customer Cash w/o APR”, for a cash back amount of $2500. FIGS. 11-13 depict additional potentially eligible programs.

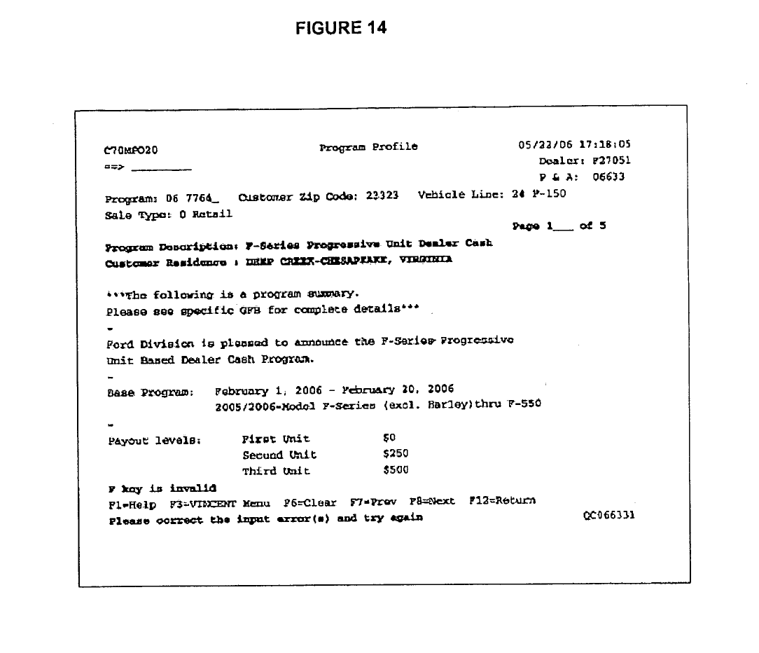

In addition to checking if a reward has already been claimed, the reward auditing program may also determine which programs are eligible to be claimed by checking various information (e.g., sales, dates, financing, and the like) in the VIN specific eligibility screens (FIGS. 10-13) with the detailed information in the program profile screens (FIGS. 14-19). This is described in further detail below.

The reward auditing program determines if the eligible programs are compatible with what has already been claimed (step 510). The process for checking eligibility and compatibility is described in further detail below with reference to FIG. 6.

Some eligible programs may not compatible with reward programs that have already been claimed. For example, annual percentage rate (APR), cash or a combination of APR and cash may not be compatible with each other. For example, when a customer buys a vehicle, they may have different options such as a cash option of $4,000, an option of 0% APR financing, or a combination of Cash and APR (e.g., $2000 and 4.9% financing), but they can only select one of the options.

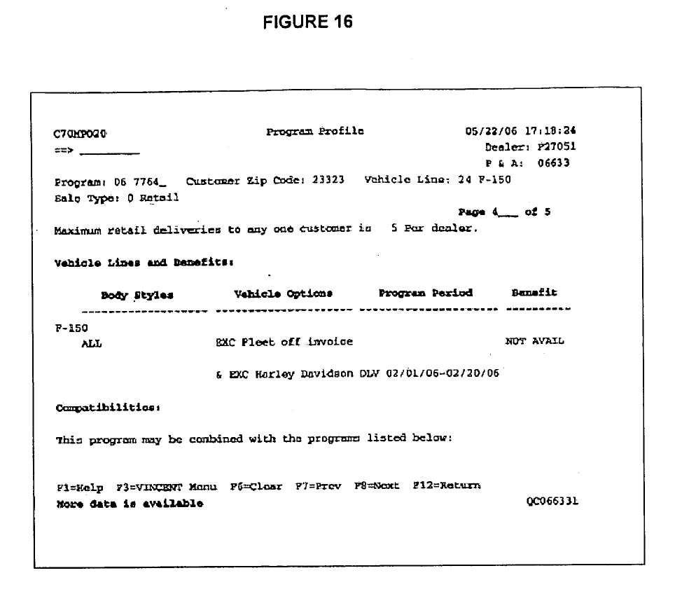

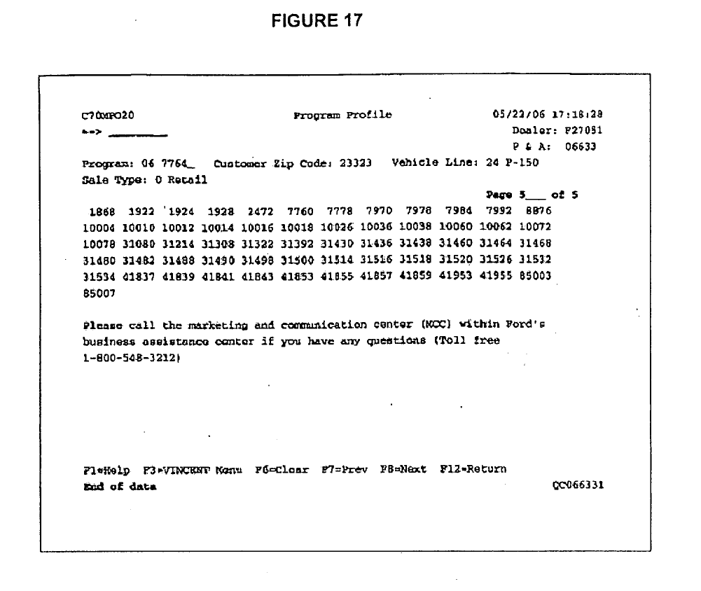

As discussed above, the reward auditing program determines the compatibility of the reward programs, one of which is shown, for example, in FIGS. 14-19. The reward auditing program selects an eligible program, such as reward Program 7764 in FIG. 10 (F-Series Progressive Unit Dealer Cash) and determines if it is compatible from the information in FIGS. 14-19 with the previously claimed rewards in FIG. 9. The “Compatibilities” shown at the bottom of FIGS. 16 and 17 show the claimed rewards that are compatible with reward Program 7764. In one implementation, all of the numbers in the claimed rewards screen (FIG. 9) have to be listed in the numbers shown at the bottom of FIG. 17 for the reward program to be compatible with what has already been claimed. The reward auditing program determines compatibility by extracting this information and comparing the respective values.

The illustrative screen of FIG. 14 depicts the following information: the program (shown as 06 7764), the Customer zip code (23323), the vehicle line (24 F-150), and sale type (O Retail). A detailed description of the illustrative reward program follows the above information. The information may include but is not limited to the following: base program, payout levels, financing requirements, previous ownership proof, vehicle sold status, sale type, vehicle lines, dates of program, benefits and compatibilities. The reward auditing program determines if the reward program selected in FIGS. 14-19 is compatible with the previously claimed rewards in FIG. 9 by cross referencing the numbers on screen of FIG. 9 with those at the bottom of the screens in FIG. 17 to determine if, in one implementation, all of those in FIG. 9 appear at the bottom of FIG. 17. Otherwise, an already-claimed reward is not compatible with the reward program being examined.

If there are no compatible eligible rewards, the reward auditing program may start over by checking the next VIN numbers or ending (step 502).

If a reward program has not already been claimed and is eligible and compatible with what is already claimed, then the reward auditing program claims the eligible reward by notifying the user or appropriate system of the information to claim it, or by automatically claiming it with the manufacturer system (step 512). The reward auditing program notifies the user, for example, by prompting the user on the user system display, sending an e-mail, a fax or letter. The reward auditing program may claim the reward with the manufacturer system, for example, by sending a notification to the manufacturer program.

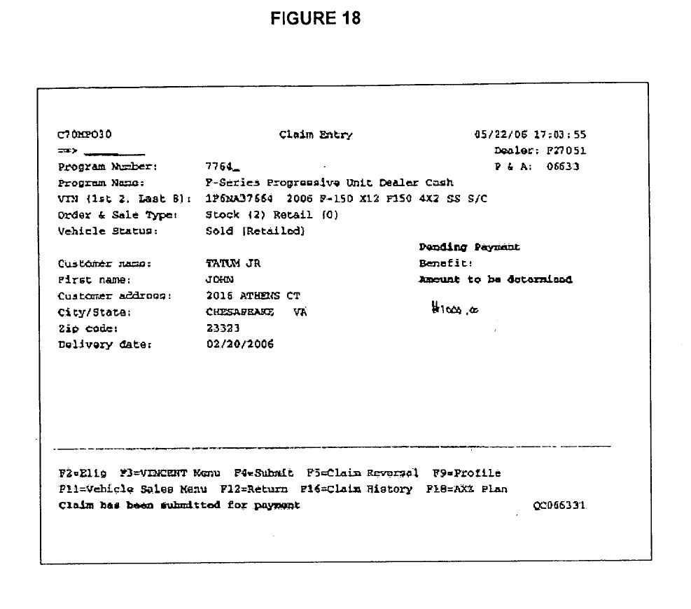

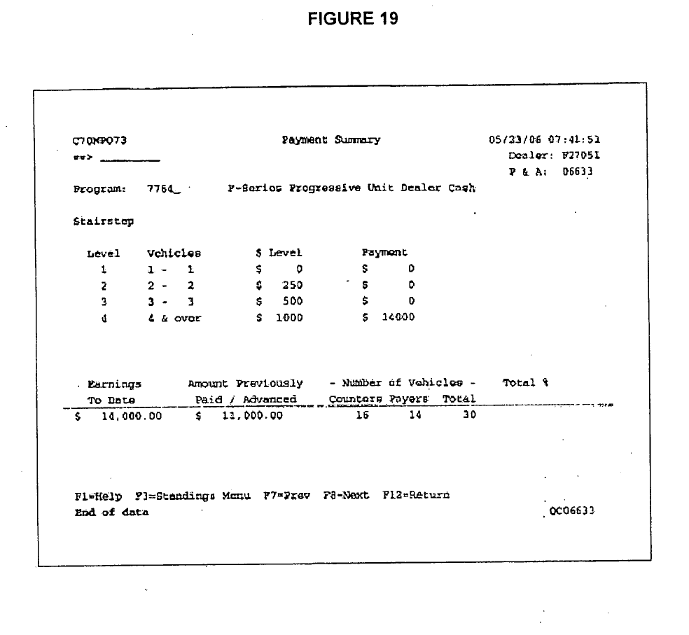

In one implementation, the reward auditing program enters the manufacturer system claiming screen (FIGS. 18 and 19) to claim the reward. FIG. 18 shows an illustrative screen shot of the reward auditing system claiming the reward. In the illustrative example, there is a pending payment, benefit amount, the vehicle information and the customer's information. FIG. 19 depicts a screen shot that shows a summary (including reward amount) of the reward claimed in FIG. 18.

After the eligible reward is claimed, the reward auditing program determines whether there are additional VIN numbers (step 514) and if there are none, the program may end.

FIG. 6 depicts a flowchart of exemplary steps performed by the reward auditing program for determining eligibility and compatibility of a reward program. The reward auditing program checks a potential reward to see if it can be claimed (step 602). To do so, the reward auditing program checks to see if the reward program has already been claimed (step 604). The VIN Eligibility Screen (FIG. 10) shows the program number (Pgm Num) on the left side of the screen. The reward auditing program compares this program number with the previously claimed rewards shown on the Claim History by VIN (FIG. 9). The Claim History by VIN (FIG. 9) has the program numbers shown on the left side of the screen. If the program number being checked is currently listed under the Claim History by VIN (FIG. 9), then the reward auditing program detects that the reward is already claimed and searches for more reward programs under the VIN Eligibility Screen (FIG. 10) (step 616). If there are no more reward program numbers available to search, the reward auditing program checks the next VIN number provided (see step 514). If there are more reward programs to search (step 616), the reward auditing program checks the next reward program (step 618) and repeats the above cycle until either the reward auditing program runs out of reward programs or finds a reward program not shown on the Claim History by VIN (FIG. 9).

Once a reward program is available to be claimed (located on the VIN Eligibility Screen (FIG. 10) but not currently listed on the Claim History by VIN (FIG. 9)), the reward auditing program checks the reward program for both eligibility and compatibility (step 606). For the reward program being checked, a reward program profile (FIGS. 14-17) is analyzed to search for eligibility and compatibility. The details of what the reward auditing program analyzes to determine the eligibility and compatibility are described below. The reward auditing program looks for eligibility by comparing that information described below with reference to FIGS. 14-17 (step 608). If the reward program information is not eligible, the reward auditing program searches for the next reward program as stated above if there is another reward program (steps 616 and 618).

If the reward program is eligible, then the reward auditing program looks for compatibility by analyzing the Program Profile (FIGS. 14-17) (step 610). Listed at the bottom of the Program Profile (FIG. 17), there are lists of numbers that correspond to other reward program numbers with which the current reward program is compatible. To be compatible, the reward program numbers listed in the Claim History by VIN (FIG. 9) must be listed in the reward program numbers shown in the Program Profile (FIGS. 14-17).

If the reward program number being checked is not listed, the reward auditing program searches for more reward programs numbers as stated above (steps 616 and 618). In the illustrative example, if the reward program number is listed as a compatible program (FIG. 17), the reward auditing program then checks to see if a Certification number is required to claim the reward program (step 612). A Certification number is a special number issued to select people by the manufacturer, such as people who own similar vehicles, companies, people who applied via the Internet, and the like. If a Certification number is required, the reward auditing program notifies the user that one is needed and asks if the user has one (step 613). If none is available from the user, the reward auditing program searches for more program numbers as stated above (steps 616 and 618). If no Certification is required (step 612) or a certification is available from the user (step 613), the reward program is then claimed (step 614). After the reward program is claimed, the reward auditing program searches to see if any more reward program numbers are available (step 616), and if so, checks the next reward program (step 618) as above.

The details of what is compared to check eligibility are now discussed. The reward auditing program uses information provided by the dealership in conjunction with the information from the manufacturer system website (e.g., the Vincent system.) The reward auditing program verifies eligibility by comparing the information within the Program Profile (FIGS. 14-17) with the information in the VIN Specific Eligibility (FIG. 10). In an illustrative example, the information to be verified in the VIN Specific Eligibility screen (FIG. 10) is the following:
Vehicle Line (F150 X12 F150 4X2 SS S/C)
Delivery Date (Feb. 20, 2006)
Sale Type (Retail (0))
Financing Information (Term 60 Months).

The reward auditing program compares this information with the corresponding information contained in the Program Profile (FIGS. 14-17) to determine eligibility.

The Vehicle Line is verified under the heading ‘Body Styles’ of the screen of FIG. 16. That heading includes the entry ‘F-150 All,’ and therefore the reward auditing program determines that the example Vehicle Line (F150 X12 F150 4X2 SS S/C) is verified and meets eligibility.

On the screen of FIG. 16, the reward auditing program verifies the Delivery Date under the heading ‘Program Period.’ In this case, the information under that heading shows the program dates to be Feb. 1, 2006-Feb. 20, 2006. Thus, the delivery date of Feb. 20, 2006 falls within the program eligibility dates and meets eligibility as determined by the reward auditing program.

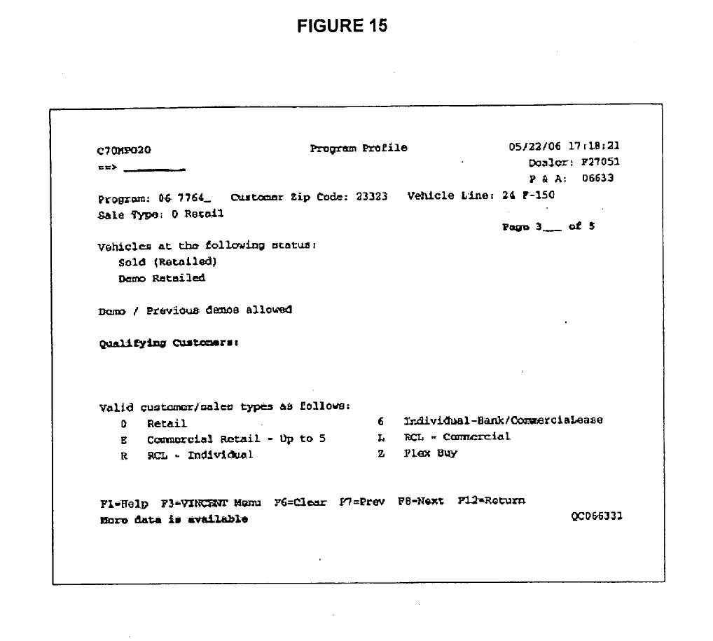

The Sale Type is verified under the heading ‘Valid Customer/Sales types’ as shown on the screen of FIG. 15. The sale type is ‘0 Retail,’ thus the sale type (0 Retail) is verified and meets eligibility.

In this illustrative example of the Program Profile (FIGS. 14-17), there are no financing requirements shown. If there were requirements, they may appear, for example, on the screens of FIG. 14 or 15 under the heading ‘Financing Requirements,’ as ‘Retail Sale—Yes or No,’ or ‘RCL (Red Carpet Lease) Yes or No.’

Although methods and systems described herein are described with respect to automobiles, they may be utilized with respect of other types of products, businesses, items, rewards, or financial programs. Further, as noted above one or more of the illustrative steps described with reference to FIGS. 5 and 6 may be performed manually or in combination with automatically by the reward auditing program.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed:

1. A method in a data processing system having a reward auditing program for managing customer rewards, the method performed by the reward auditing program comprising the steps of:
accessing a manufacturer data processing system that includes a reward information associated with a product;
determining whether a reward is available for a product from the reward information; and
notifying a customer when the reward is available.

2. The method of claim 1 further comprising the step of:
claiming the reward.

3. The method of claim 1 further comprising the step of:
determining whether a reward has already been claimed for the product.

4. The method of claim 1 further comprising the step of:
determining one or more rewards of a plurality of rewards are eligible to be claimed for the product.

5. The method of claim 1, wherein the reward is at least one of a rebate, an incentive, money, and a percentage rate.

6. The method of claim 1, wherein the product is a vehicle.

7. A computer-readable medium containing instructions that cause a data processing system to perform a method for managing customer rewards, the method comprising the steps of:
accessing a manufacturer data processing system that includes a reward information associated with a product;
determining whether a reward is available for a product from the reward information; and
notifying a customer when the reward is available.

8. The computer-readable medium of claim 7 further comprising the step of:
claiming the reward.

9. The computer-readable medium of claim 7 further comprising the step of:
determining whether a reward has already been claimed for the product.

10. The computer-readable medium of claim 7 further comprising the step of:
determining one or more rewards of a plurality of rewards are eligible to be claimed for the product.

11. The computer-readable medium of claim 7, wherein the reward is at least one of a rebate, an incentive, money, and a percentage rate.

12. The computer-readable medium of claim 7, wherein the product is a vehicle.

13. A data processing system comprising:
a memory having a reward auditing program for managing customer rewards that accesses a manufacturer data processing system that includes a reward information associated with a product, determines whether a reward is available for a product from the reward information, and notifies a customer when the reward is available; and
a processing unit that runs the program.

14. The data processing system of claim 13, wherein the reward auditing program claims the reward.

15. The data processing system of claim 13, wherein the reward auditing program determines whether a reward has already been claimed for the product.

16. The data processing system of claim 13, wherein the reward auditing program determines one or more rewards of a plurality of rewards are eligible to be claimed for the product.

17. The data processing system of claim 13, wherein the reward is at least one of a rebate, an incentive, money, and a percentage rate.

18. The data processing system of claim 13, wherein the reward auditing program, wherein the product is a vehicle.
